(19) United States
(12) Patent Application Publication
(10) Pub. No.: US 2008/0150919 A1
(43) Pub. Date: Jun. 26, 2008

(54) Electronic paper display device and a system for interfacing an application

(75) Inventor: Toshifumi Kanamaru, Tokyo (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/003,418

(22) Filed: Dec. 26, 2007

(30) Foreign Application Priority Data
Dec. 26, 2006 (JP) JP-2006-350244

(51) Int. Cl. G06F 3/033

(52) U.S. Cl. 345/179

(57) ABSTRACT

An electronic paper display device includes a display for displaying image or text data, a storage for storing the image or text data to be displayed on the display, a controller for controlling the display, and an interface connectable to another electronic device to transmit or receive data to or from the other electronic device. The storage stores a program sequence for analyzing the data received through the interface. When receiving the data from the other electronic device, the interface feeds the data thus received to the controller, so that the controller reads out and runs the program sequence stored in the storage to analyze the data, and controls the display to display the data thus analyzed.

### FIELD OF THE INVENTION

The present invention relates to an electronic paper display device and a system for interfacing applications between different electronic paper display devices.

### DESCRIPTION OF THE BACKGROUND ART

As a type of electronic paper or e-paper, Japanese patent laid-open publication No. 2005-267170, for example, discloses an electronic paper display device manipulatable in a manner allowing the user to sensuously grasp the processing of information to be displayed on its display screen, instead of any button operation. More specifically, the electronic paper display device disclosed comprises, for example, a pressure sensor which detects a stress caused when the electronic paper display device becomes deformed, or an acceleration sensor which detects acceleration caused when the electronic paper display device is moved. The pressure sensor may also detect a pressure applied to the electronic paper display device when grasped or rubbed. The electronic paper display device has a controller operative in response to the pressure or acceleration sensor having detected the stress, pressure or acceleration to execute the process of, e.g. erasing the data displayed on the display of the electronic paper display device.

This conventional electronic paper display device enables the user to perform processing without the button operation, although it has some problems in compatibility. Specifically, it is difficult for the conventional electronic paper display device to accomplish data sharing, interaction and cooperation with other electronic paper display devices. In addition, processes which can be dealt with by the conventional electronic paper display devices are restricted to simple ones.

### SUMMARY OF THE INVENTION

It is therefore an object of the present invention to provide an electronic paper display device which enables users to operate sensuously and can share data between applications of other electronic paper display devices. It is also an object of the invention to provide a system for interfacing applications for use in different electronic paper display devices.

In accordance with the present invention, an electronic paper display device includes a display for displaying image or text data, a storage for storing the image or text data to be displayed on the display, a controller for controlling the display, and an interface for interfacing another electronic device to at least receive data from the other electronic device. The storage stores a program sequence for analyzing the data received through the interface. When receiving the data from the other electronic device, the interface feeds the data thus received to the controller, so that the controller reads out and runs the program sequence stored in the storage to analyze the data, and controls the display to display the data thus analyzed.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing an embodiment of an electronic paper display device according to the present invention;

FIG. 2 schematically shows an example of interconnecting in plural the electronic paper display devices shown in FIG. 1;

FIG. 3 is a front view schematically showing the electronic paper display devices shown in FIG. 2 connected to each other to carry out data communications with each other;

FIG. 4 schematically shows an example of sharing data between email and scheduling applications in the electronic paper display devices according to the embodiment;

FIGS. 5 and 6 schematically show examples of sharing data between email and word processing applications in the electronic paper display devices according to the embodiment;

FIG. 7 is a view schematically showing an example of sharing data between Web browser, map and personal information manager applications in the electronic paper display devices according to the embodiment;

FIG. 8 is a schematic block diagram, like FIG. 1, showing an alternative embodiment of the electronic paper display device according to the present invention;

FIG. 9 schematically shows an example of sharing data between document reader applications in the electronic paper display devices shown in FIG. 8;

FIG. 10 is a schematic block diagram, like FIG. 1, showing another alternative embodiment of the electronic paper display device according to the present invention;

FIG. 11 is a front view schematically showing a touch panel included in the alternative embodiment shown in FIG. 10;

FIG. 12 schematically shows an example of sharing data between document reader applications in the electronic paper display devices shown in FIG. 10; and

FIG. 13 schematically shows an example of interconnection between a computer and the electronic paper display device according to the invention.

### DESCRIPTION OF THE PREFERRED EMBODIMENTS

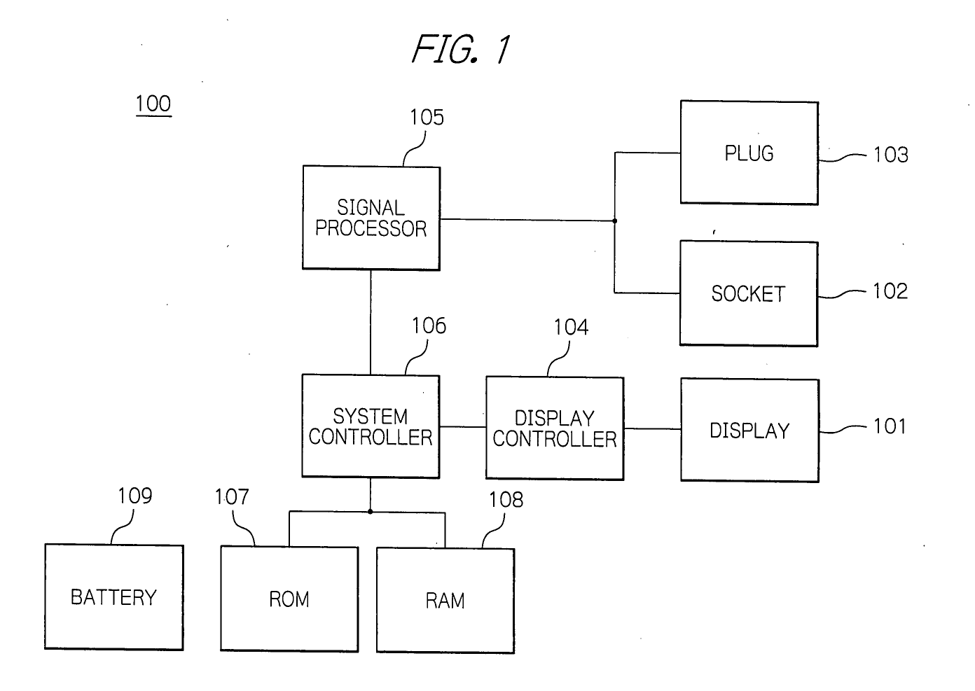

Well, with reference to the accompanying drawings, preferred embodiments of the electronic paper display device and system according to the present invention will be described in detail. First, a reference will be made to FIG. 1 showing in a schematic block diagram an embodiment of an electronic paper display device 100 according to the present invention.

The electronic paper display device 100 includes a display panel 101, a connector socket 102, a connector plug 103, a display controller 104, a signal processor 105, a system controller 106, a ROM (Read Only Memory) 107, a RAM (Random Access Memory) 108 and a battery 109, which are interconnected as illustrated. In the figures, elements not directly relevant to the understanding of the present invention are not shown, and a description thereof will not be made.

The display panel 101 has display cell devices, not shown, adapted to be driven to visually display image or text data, i.e. display data, input thereto. The display panel 101 may be adapted to have the display cell devices maintain the display data while being visualized, advantageously without being supplied with electric power.

The connector socket 102 and plug 103 are adapted to serve as an interface for connecting the electronic paper device 100 with other electronics devices, such as other electronic paper display devices, provided with a similar connector plug or socket, respectively. More specifically, the connector socket 102 comprises receptacle slots which can receive the corresponding connector plug of another electronics device so as to transmit data to the other electronics device thus connected. The connector plug 103 comprises connector pins which can insert the slots of a socket provided with the other electronics device to be connected so as to receive data transmitted from the connected electronics device.

The display controller 104 is adapted to control the display panel 101 under the control of the system controller 106, i.e. functions as a driver of the display panel 101. More specifically, the display controller 104 supplies control signals to the display panel 101 to control and drive the display cell devices so as to allow the display panel 101 to display display data.

The signal processor 105 is adapted to control the connector socket 102 and plug 103 and execute necessary signal processing for transmitting and receiving the data, respectively. In the illustrative embodiment, when transmitting and receiving data, for example, the signal processor 105 converts data formats to a format acceptable for the connector socket 102 and plug 103.

The system controller 106 is a general controller adapted to control the entire operation of the electronic paper display device 100 in response to, e.g. an operation signal received from the control panel, not shown, or another controller, and includes a CPU (Central Processing Unit) by way of example. In the illustrative embodiment, the system controller 106 provides a control signal to the display controller 104 so as to have the latter drive the display cell devices in the display panel 101. The system controller 106 also provides a control signal to the signal processor 105 so as to have the latter transmit or receive data. The system controller 106 is also adapted read out a program sequence stored in the ROM 107 to run the program sequence. Furthermore, the system controller 106 is adapted to read out and write data from and to the RAM 108.

The ROM 107 and RAM are of known types of storage and adapted to store program sequences and data, etc., needed for any processing to be performed in the electronic paper display device 100. In the illustrative embodiment, the ROM 107 stores program sequences which are designed for use in the electronic paper display device 100, and the RAM 108 stores data which is processed or to be processed by the program sequences stored in the ROM 107 to be displayed on the display panel 101.

The battery 109, which may be of a rechargeable type, is adapted to supply electric power to parts of the electronic paper display 100. The electronic paper display device 100 may also comprise, if necessary, a wireless communication system with a wireless network interface such as an antenna.

The display controller 104 and the signal processor 105 can be implemented with hardware such as a microcomputer or circuit device, or software which is runnable on the system controller 106.

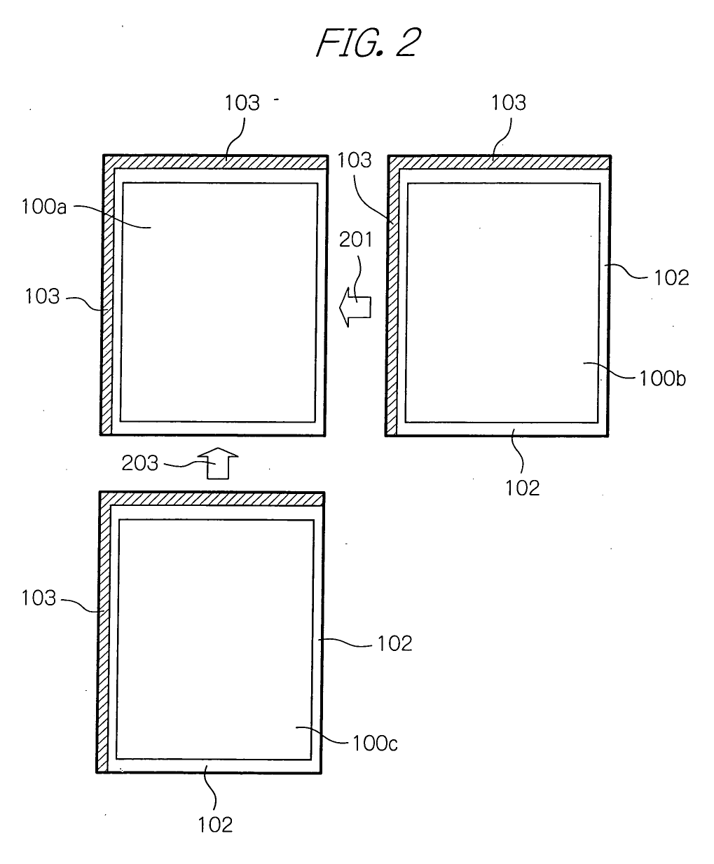

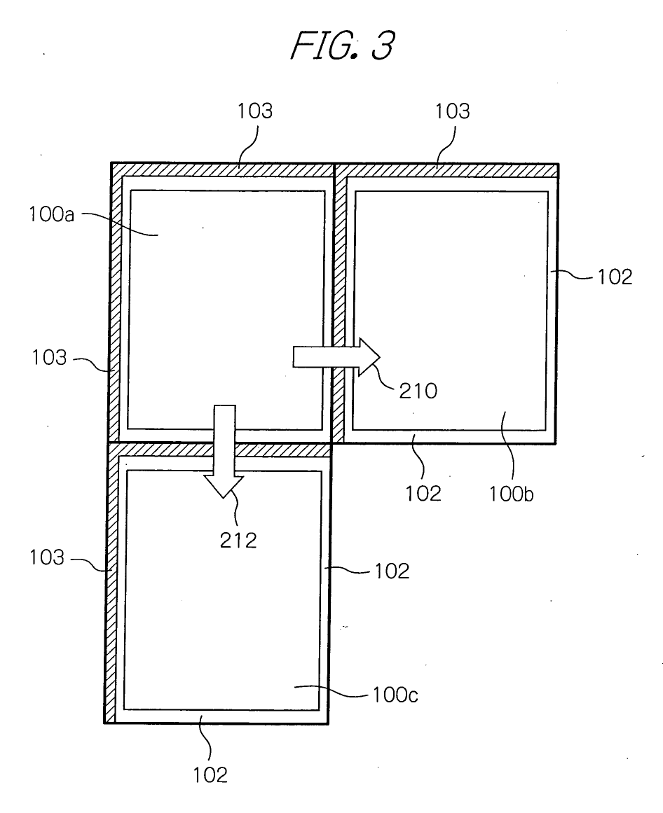

FIGS. 2 and 3 schematically show an example of a combination of a plurality of, e.g. three, electronic paper display devices 100a, 100b and 100c, which are equivalent to the electronic paper display device 100 shown in and described with reference to FIG. 1. Each electronic paper device, e.g. 100a, has the connector plug 103 which includes connector pins or metal contacts located on the upper and left edges of the device 100a in the figure, and the socket 102 which is located on the lower and right edges of the device 100a in the figure and connectable with the connector plug 103 of the mating electronic paper device, e.g. 100c or 100b.

In the illustrative embodiment, the left connector plug 103 of the electronic paper display device 100b is inserted into the right socket 102 of the electronic paper display device 100a, and the upper connector plug 103 of the electronic paper display device 100c is inserted into the lower socket 102 of the electronic paper display device 100a, as indicated by arrows 201 and 203, respectively, in FIG. 2.

Of course, the configuration of the connector plug 103 and socket 102 shown in FIGS. 2 and 3 is only illustrative and may be freely changed or modified as long as the data transmission and reception is possible. The engageable connection such as connection between the connector plug 103 and socket 102 increases in strength of the connection and is therefore suited for the data sharing executed by moving the electronic paper display devices thus interconnected.

Next, a description will be made of an example of the procedure of data communication between the electronic paper display devices 100a and 100b.

First, the connector plug 103 of the electronic paper display device 100b is inserted into the mating connector socket 102 of the electronic paper display device 100a.

Then, the signal processor 105 of the electronic paper display device 100a receives a notification of the connection from the socket 102, and feeds a signal indicative of the notification to its own system controller 106.

The system controller 106 of the electronic paper display device 100a reads out data stored in the RAM 108 and feeds the data to the signal processor 105.

The signal processor 105 of the electronic paper display device 100a receives the data from the system controller 106, performs signal processing on the data, if necessary, in order to formulate the data which can meet the form of specifications of the socket 102, and feeds the data thus processed to the socket 102.

The data is then output from the socket 102 of the electronic paper 100a to the connector plug 103 of the electronic paper 100b.

The connector plug 103 of the electronic paper display device 100b receives the data transmitted from the socket 102 of the electronic paper display device 100a, and feeds the data thus received to the signal processor 105 of the electronic paper display device 100b.

The signal processor 105 of the electronic paper display device 100b performs necessary processing on the data, such as analog-to-digital conversion, so as to feed the processed data to the system controller 106. The system controller 106 has the RAM store the data.

In this way, the data contained in the electronic paper display device 100a can be transmitted to the electronic paper display device 100b as indicated by an arrow 210 in FIG. 3. It is also possible to execute data communication between the electronic paper display devices 100a and 100c in the same manner as the data communication between the electronic paper display devices 100a and 100b. In the figure, the data flow from the electronic paper display device 100a to the electronic paper display device 100c is indicated by an allow 212.

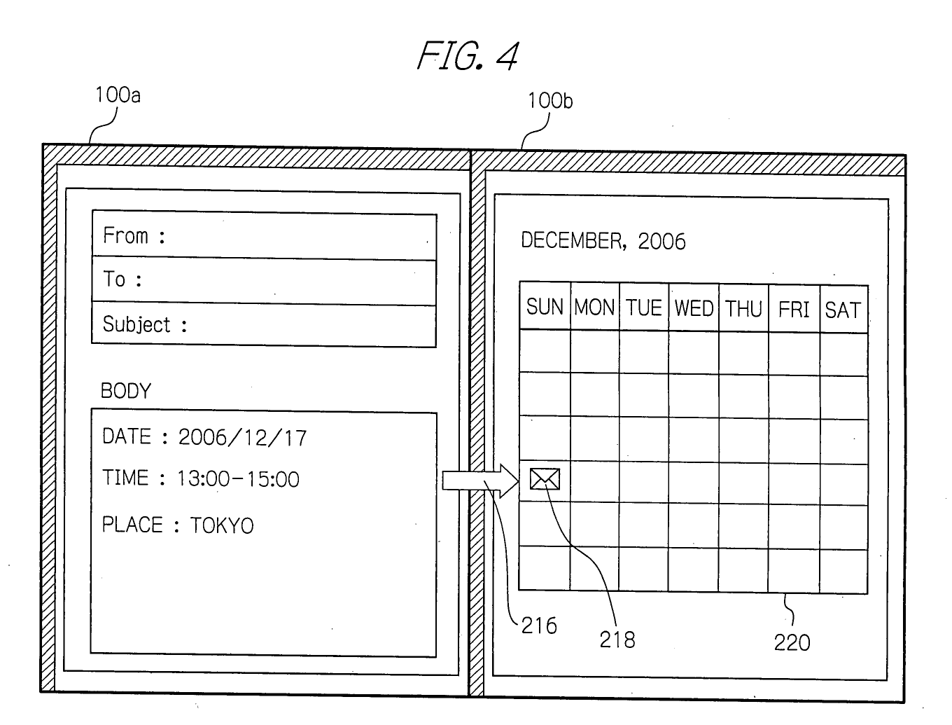

Now, a description will be made on examples of the data sharing between applications installed in the plurality of electronic paper display devices connected, with reference to FIGS. 4 to 7.

FIG. 4 schematically shows an example of sharing data between email and scheduling applications. Note that, this data sharing is based on the premise that, in the ROM 107 of the electronic paper display devices 100a and 100b, email and scheduling applications have been already installed, respectively. These applications are on standby and ready for an execution of the data sharing.

When the electronic paper display device 100a receives an email by the email application through a known network interface such as a wireless communication interface, the display device 100a stores the email in the RAM 108. In the example being described, the content, or message, of the email stored in the RAM 108 of the electronic paper device 100a is information about the date and place associated with a schedule, which are written in the email in a predetermined format.

In order to execute data sharing between the electronic paper display devices 100a and 100b, the connector plug 103 of the electronic paper 100b is inserted into the socket 102 of the electronic paper 100a. Note that, in the electronic paper display device 100b, the scheduling application is ready for execution of data sharing.

When the connector plug 103 of the electronic paper display device 100b is inserted into the socket 102 of the electronic paper display device 100a, the signal processor 105 of the electronic paper display device 100a receives a signal indicating a notification of the connection from the socket 102, and outputs the signal to its own system controller 106.

The system controller 106 of the electronic paper display device 100a, then, reads out the email message or data from the RAM 108 and feeds the email data to the signal processor 105. The signal processor 105 of the electronic paper 100a receives the email data, performs necessary processing on the email data in order to formulate the data acceptable for the specifications of the socket 102, and feeds the data thus processed to the socket 102.

From the socket 102 of the electronic paper display device 100a, the data is then transmitted to the connector plug 103 of the electronic paper display device 100b.

When receiving the data transmitted from the socket 102 of the electronic paper 100a, the connector plug 103 of the electronic paper display device 100b feeds the data to the signal processor 105 of the electronic paper 100b.

The signal processor 105 of the electronic paper display device 100b performs necessary processing on the data, such as analog-to-digital conversion, so as to feed the processed data to the system controller 106. The system controller 106 has the RAM store the data.

The system controller 106 of the electronic paper display device 100b then follows the program instructions of the scheduling application to read out the email data from the RAM 108 and extract the information about schedule data from the email data so as to update the schedule data of the scheduling application relating to the date as indicated by an arrow 216 in FIG. 4.

More specifically, on the display panel 101 of the electronic paper display device 100b, a picture figure or icon 218 indicating email is made on the date in the calendar 220 which date is described in the email received by the electronic paper display device 100a.

In this way, the email data can be shared between the electronic paper display devices 100a and 100b simply by connecting the electronic paper display device 100a with the electronic paper display device 100b as described above, and it is therefore possible to calendarize the schedule, which has informed by email, without a need for inputting the date and time even if the email application is not installed in the electronic paper display device 100b.

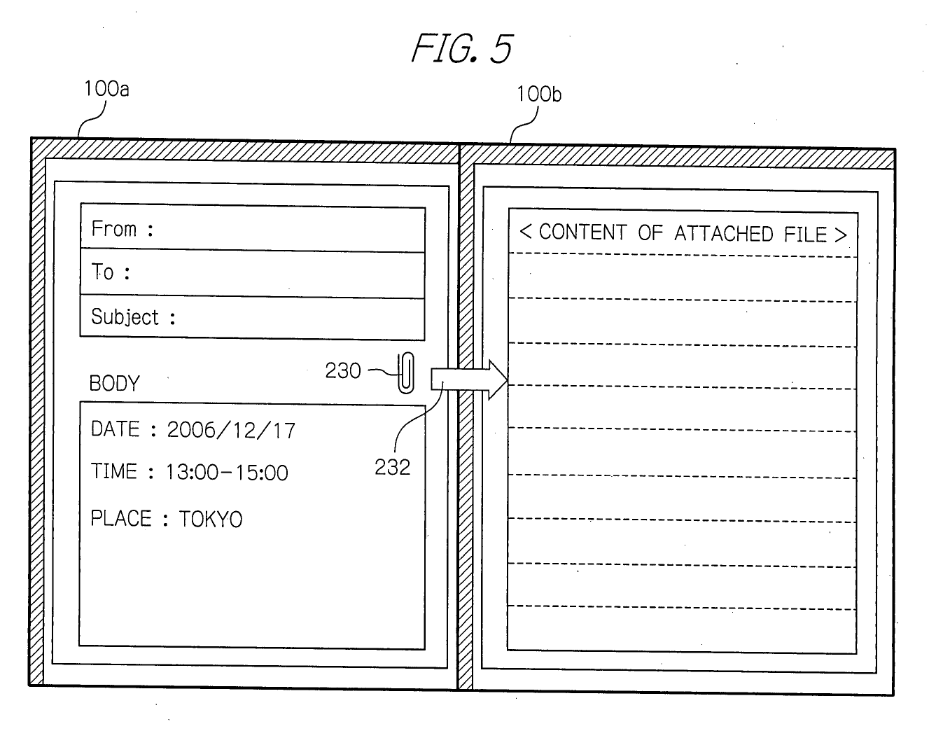

FIG. 5 schematically shows an example of sharing data between email and word processing applications. Note that, this data sharing is based on the premise that, in the ROM 107 of the electronic paper display devices 100a and 100b, email and word processing applications have been already installed, respectively.

When receiving an email attached a file 230 created by the word processing application, the electronic paper display device 100a stores the email in the RAM 108 in a similar fashion as the data sharing described in FIG. 4.

In order to execute data sharing between the electronic paper display devices 100a and 100b, the connector plug 103 of the electronic paper display device 100b is inserted into the socket 102 of the electronic paper display device 100a. In the electronic paper display device 100b, the word processing application is on standby and ready for an execution of the data sharing.

When the connector plug 103 of the electronic paper display device 100b is inserted into the socket 102 of the electronic paper display device 100a, the signal processor 105 of the electronic paper display device 100a receives a signal indicating a notification of the connection from the socket 102, and outputs the signal to its own system controller 106.

The system controller 106 of the electronic paper display device 100a, then, reads out file data attached thereto from the RAM 108 and outputs the attached file data to the signal processor 105. The signal processor 105 of the electronic paper display device 100a receives the attached file data from the system controller 106, performs necessary processing on the attached file data in order to formulate the data acceptable for the specifications of the socket 102 and outputs the data thus processed to the socket 102.

From the socket 102 of the electronic paper display device 100a, the data is then transmitted to the connector plug 103 of the electronic paper display device 100b.

When receiving the data transmitted from the socket 102 of the electronic paper 100a, the connector plug 103 of the electronic paper display device 100b feeds the data to the signal processor 105.

The signal processor 105 of the electronic paper display device 100b performs necessary processing on the data, such as analog-to-digital conversion, so as to feed the processed data to the system controller 106. The system controller 106 has the RAM store the data.

The system controller 106 of the electronic paper display device 100b then follows the program instructions of the word processing application to read out the word-processed data, i.e. the attached file data from the RAM 108 so as to display the attached file data on the editing screen of the word processing application as indicated by an arrow 232 in FIG. 5.

In this way, the word-processed data can be shared between the electronic paper display devices 100a and 100b simply by connecting the electronic paper display device 100a with the electronic paper display device 100b as described above. It is therefore possible to view and confirm the content of the attached file even if the word processing application is not installed in the electronic paper display device 100a.

Note that, in the illustrative example, attached file data is shared between the electronic paper display devices by way of example. However, any data such as the body of an email message may be shared.

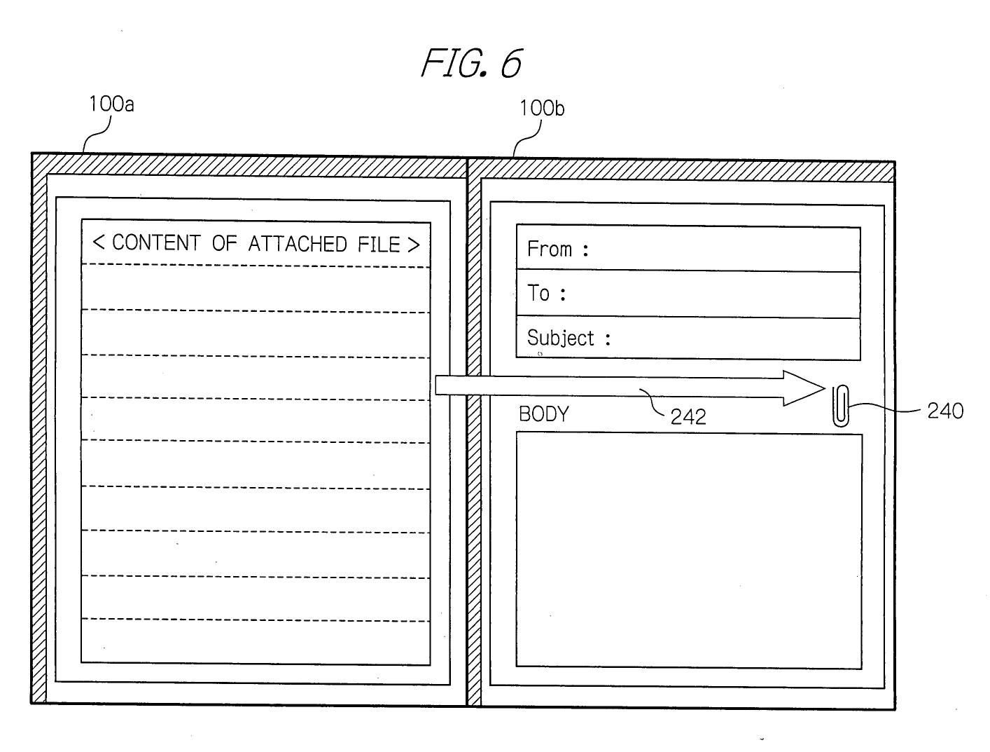

FIG. 6 schematically shows another example of sharing data between email and word processing applications. Note that, this exemplified data sharing is based on the premise that, in the ROM 107 of the electronic paper display devices 100a and 100b, word processing and email applications have been already installed, respectively. These applications are on standby and ready for an execution of the data sharing.

In the ROM 108 of the electronic paper display device 100a, data of a word-processed file to be attached to an email is also stored. The word-processed file may be a file which has been drew up separately on a personal computer and transmitted to the electronic paper display device, as described below.

In order to execute data sharing between the electronic paper display devices 100a and 100b, the connector plug 103 of the electronic paper display device 100b is inserted into the socket 102 of the electronic paper display device 100a. Note that, in the electronic paper display device 100b, the email application is ready for execution of data sharing.

When the connector plug 103 of the electronic paper display device 100b is inserted into the socket 102 of the electronic paper display device 100a, the signal processor 105 of the electronic paper display device 100a receives a signal indicating a notification of the connection from the socket 102, and outputs the signal to its own system controller 106.

The system controller 106 of the electronic paper display device 100a, then, reads out the word-processed file data from the RAM 108 and feeds the data to the signal processor 105. The signal processor 105 of the electronic paper display device 100a receives the data, performs necessary processing on the data in order to formulate the data acceptable for the specifications of the socket 102, and outputs the data thus processed to the socket 102.

From the connector socket 102 of the electronic paper display device 100a, the data is then transmitted to the connector plug 103 of the electronic paper display device 100b.

When receiving the data transmitted from the socket 102 of the electronic paper display device 100a, the connector plug 103 of the electronic paper display device 100b feeds the data to the signal processor 105 of the electronic paper display device 100b.

The signal processor 105 of the electronic paper display device 100b performs necessary processing on the data, such as analog-to-digital conversion, so as to feed the processed data to the system controller 106.

The system controller 106 of the electronic paper display device 100b follows the program instructions of the email application to read out the word-processed data from the RAM 108 and execute the processing of making a file, symbolically shown by a reference numeral 240, and attaching the file 240 to an email.

Note that, since the file can be made and attached simply through encoding the word-processed file read out from the RAM 108 with the use of, e.g. Base 64 encoding, the word processing application need not be installed in the electronic paper display device 100b.

In this way, the word-processed data can be shared between the electronic paper display devices 100a and 100b simply by connecting the electronic paper display device 100a with the electronic paper display device 100b as described above. It is therefore possible to make a file in order to attach the file to an email as indicated by an arrow 242 in FIG. 6, even if the word processing application is not installed in the electronic paper display device 100b.

Note that, in the illustrative embodiment, attached file data is shared between the electronic paper display devices by way of example. However, any data such as the body of an email message may be made with the use of the word processor application.

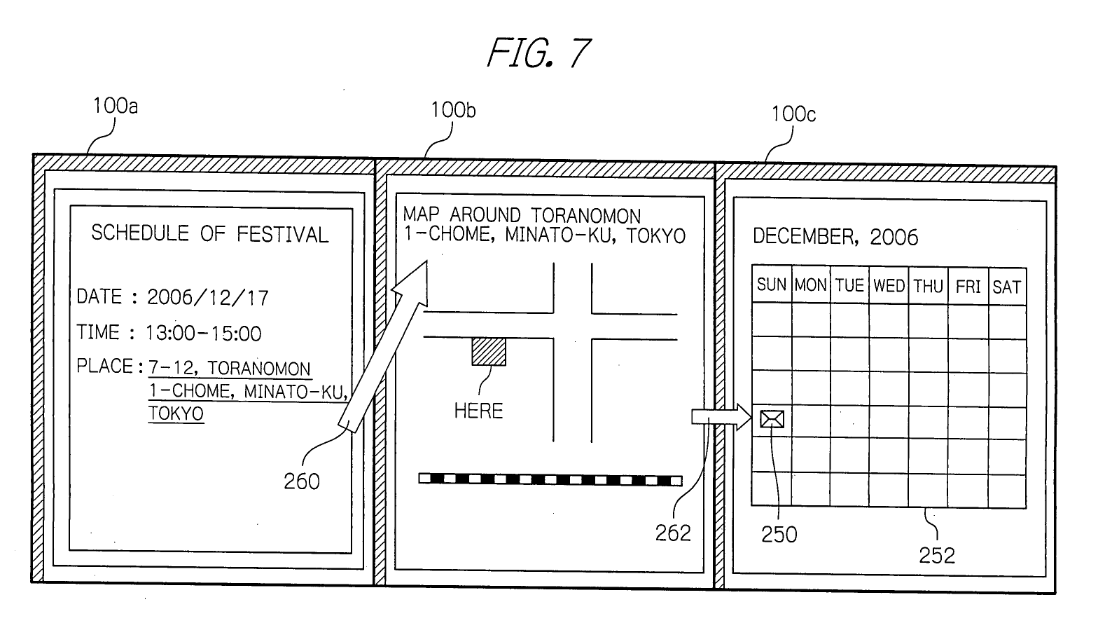

Now, a reference will be made to FIG. 7 schematically showing an example of sharing data between Web browser, map and scheduling applications. Note that, this data sharing is based on the premise that, in the ROM 107 of the electronic paper display devices 100a, 100b and 100c, Web browser, map and scheduling applications have been already installed, respectively. These applications are on standby and ready for an execution of the data sharing.

In the electronic paper display device 100a, the Web browser application opens the Web page of a predetermined URL (Uniform Resource Locator) and displays the Web page on the display panel 101. In the illustrative example, the Web page is of a festival and provides information on date and place of the festival as shown in FIG. 7 in a predetermined format.

In order to execute data sharing between the electronic paper display devices 100a and 100b, the connector plug 103 of the electronic paper display device 100b is inserted into the socket 102 of the electronic paper display device 100a. Note that, in the electronic paper display device 100b, the map application is ready for execution of data sharing.

When the connector plug 103 of the electronic paper display device 100b is inserted into the socket 102 of the electronic paper display device 100a, the signal processor 105 of the electronic paper display device 100a receives a signal indicating a notification of the connection from the socket 102, and outputs the signal to its own system controller 106.

The system controller 106 of the electronic paper display device 100a follows the program instructions of the Web browser application to feed the data carried on the Web page such as HTML data to the signal processor 105. The signal processor 105 of the electronic paper display device 100a receives the data, performs necessary processing on the data in order to formulate the data acceptable for the specifications of the socket 102, and outputs the data thus processed to the socket 102.

From the socket 102 of the electronic paper display device 100a, the data is then transmitted to the connector plug 103 of the electronic paper display device 100b.

When receiving the data transmitted from the socket 102 of the electronic paper display device 100a, the connector plug 103 of the electronic paper display device 100b feeds the data to the signal processor 105 of the electronic paper display device 100b.

The signal processor 105 of the electronic paper display device 100b performs necessary processing on the data, such as analog-to-digital conversion, so as to feed the processed data to the system controller 106. The system controller 106 has the RAM store the data.

In order to share the data contained on the Web page between the Web browser application installed in the electronic paper display device 100a and the map application installed in the electronic paper display device 100b, the system controller 106 of the electronic paper display device 100b follows the program instructions of the map application to read out the data carried on the Web page from the RAM 108 and extract the information about a location of the festival from the data so as to have the display controller 104 display the map image of the location on the display panel 101 as shown in FIG. 7. At the same time, the system controller 106 of the electronic paper display device 100b controls the RAM 108 to store the data displayed on the on the display panel 101 in the form of files, for example.

In order to execute data sharing between the electronic paper display devices 100b and 100c, the scheduling application in the electronic paper display device 100c is launched, and the connector plug 103 of the electronic paper display device 100c is inserted into the socket 102 of the electronic paper display device 100b.

When the connector plug 103 of the electronic paper display device 100c is inserted into the socket 102 of the electronic paper display device 100b, the signal processor 105 of the electronic paper display device 100b receives a signal indicating a notification of the connection from the socket 102, and outputs the signal to its own system controller 106.

The system controller 106 of the electronic paper display device 100b reads out data carried on the Web page and map data stored in the RAM 108 and feeds the data carried on the Web page and the map data to the signal processor 105. The signal processor 105 of the electronic paper display device 100b receives the email data, performs necessary processing on the email data in order to formulate the data acceptable for the specifications of the socket 102, and feeds the data thus processed to the socket 102.

From the socket 102 of the electronic paper display device 100b, the data is then transmitted to the connector plug 103 of the electronic paper display device 100c.

When receiving the data transmitted from the socket 102 of the electronic paper display device 100b, the connector plug 103 of the electronic paper display device 100c feeds the data to the signal processor 105 of the electronic paper display device 100c.

The signal processor 105 of the electronic paper display device 100c performs necessary processing on the data, such as analog-to-digital conversion, so as to feed the processed data to the system controller 106. The system controller 106 has the RAM 108 store the data.

The system controller 106 of the electronic paper display device 100c follows the program instructions of the scheduling application to read out the data transmitted from the electronic paper display device 100b, i.e. the data carried on the Web page and the map data, from the RAM 108 and extract the information about schedule data from the data carried on the Web page so as to update the schedule data of the scheduling application and provide a link to the map image with the date.

More specifically, on the display panel 101 of the electronic paper display device 100c, the picture figure or icon 250 indicating email is formed in the section of the corresponding date in the calendar 252, which date is described on the Web page opened by the application installed in electronic paper display device 100a, and with the date provided is a link to the map image received from the electronic paper device 100b.

In this way, in accordance with the illustrative example, it is possible to perform data sharing between applications installed in the respective electronic paper display devices as indicated by arrows 260 and 262, and thus facilitate the cooperative operation of the applications. Furthermore, since the data sharing can be achieved simply in response to connecting the electronic paper display devices to each other, it is possible to provide a user-friendly system for interfacing applications for use in different electronic paper display devices.

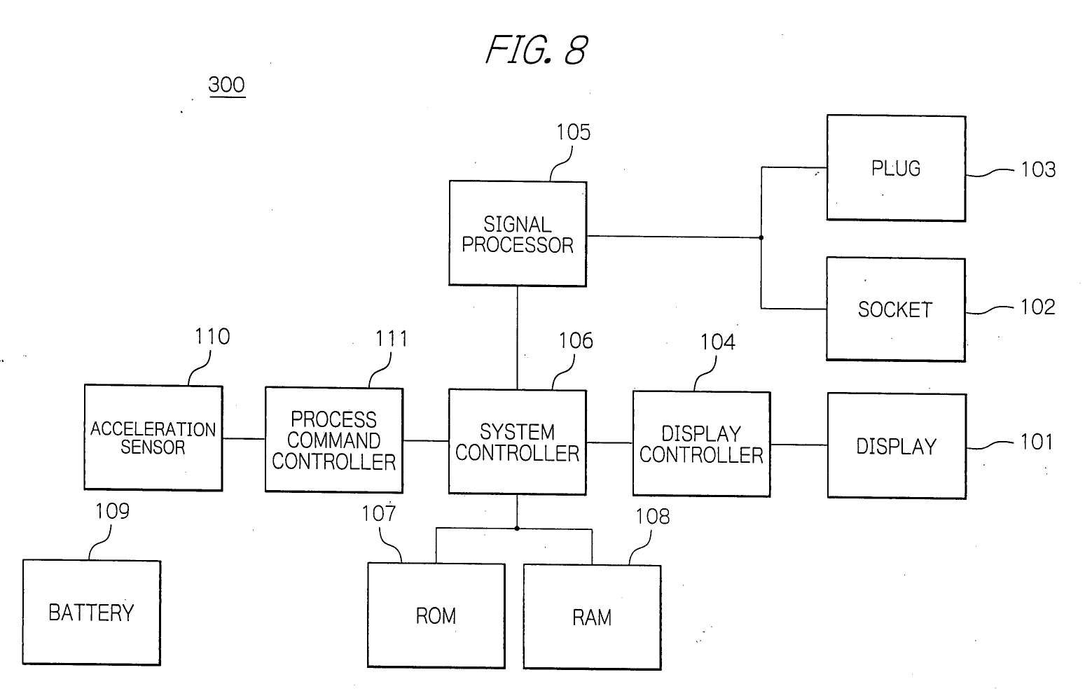

Now, reference will be made to FIG. 8, which is a schematic block diagram, like FIG. 1, showing an alternative embodiment of the electronic paper display device according to the present invention. In FIG. 8, structural parts and elements like those shown in FIG. 1 are designated by identical reference numerals, and will not be described repetitively in order to avoid redundancy.

As described in the above, in the electronic paper display device shown in the FIGS. 1 to 7, the data is transmitted only in one direction between the electronic paper display devices, i.e. from the connector socket 102 to the plug 103, whereas, in the alternative embodiment of the electronic paper display device shown in FIG. 8, the data can be transmitted in either direction, i.e. not only from the connector socket 102 to the plug 103 but also from the connector plug 103 to the socket 102. The direction of transmitting and receiving data is responsive to moving the electronic paper display device to a desired direction, as discussed in detail below.

The electronic paper display device 300 includes, in addition to the display panel 101, connector socket 102, plug 103, display controller 104, signal processor 105, system controller 106, ROM 107, RAM 108 and battery 109, an acceleration sensor 110 and a process command controller 111. Note that, in FIG. 8, the connector socket 102 and plug 103 are adapted to transmit and receive the data to and form other electronics devices such as other electronic paper display devices connectable thereto whereby data can be transmitted in either direction between the electronic paper display devices.

In FIG. 8, the acceleration sensor 110 is adapted to sense the acceleration caused when the electronic paper display device 300 is moving, or swaying, by the user, so that the direction of the movement of the electronic paper 300 can be determined. More specifically, in the alternative embodiment, the acceleration sensor 110 consists of, for example, a gyro sensor which is adapted to detect, when the user moves the electronic paper display device 300, the moving direction thereof to feed a signal indicative of the moving direction of the electronic paper device to the process command controller 111.

The process command controller 111 is adapted to perform necessary processing on the signal, such as analog-to-digital conversion, fed from the acceleration sensor 110 and indicative of the moving direction of the electronic paper display device 300 so as to feed the processed signal to the system controller 106.

The process command controller 111 can be implemented with hardware such as a microcomputer or circuit device, or software which is runnable on the system controller 106.

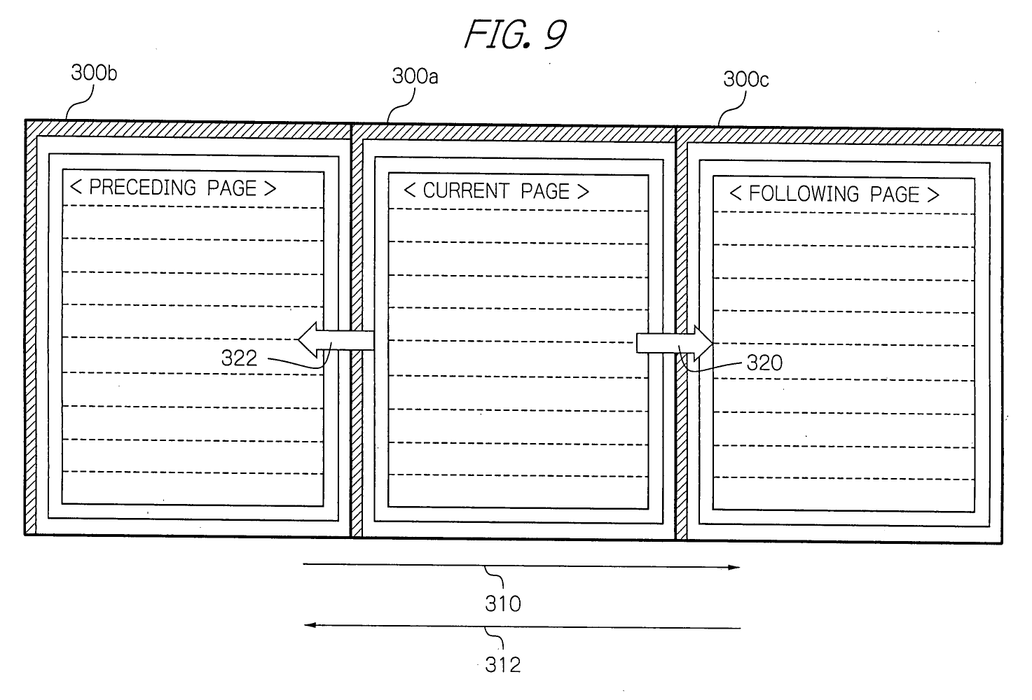

FIG. 9 schematically shows an example of sharing data between document reader applications which are installed in the respective electronic paper display devices 300 provided in plural. More specifically, the exemplified data sharing is based on the premise that three electronic paper display devices 300a, 300b and 300c have the same configuration as the electronic paper display device 300 shown FIG. 8. In the ROM 107 of each electronic paper display device, a document reader application has been already installed. The RAM 108 of the electronic paper display device 300a has a document file stored such that the display device 300a displays on its display panel 101a predetermined page, for example, page one, of the document file whereas the RAMs 108 of the electronic paper display devices 300b and 300c have no document file stored.

In order to execute data sharing between the electronic paper display devices 300a and 300b, the connector plugs 103 of the electronic paper display devices 300a and 300c are inserted into the sockets 102 of the electronic paper display devices 300b and 300a, respectively. Note that, in the electronic paper display devices 300b and 300c, the document reader application is ready for execution of data sharing.

When the connector plugs 103 of the electronic paper display devices 300a and 300c are inserted into the sockets 102 of the electronic paper display devices 300b and 300a, respectively, the signal processor 105 in each of the electronic paper display devices 300a and 300b receives a signal indicating a notification of the connection from the respective socket 102, and outputs the signal to its own system controller 106.

When the user moves the electronic paper display devices 300a, 300b and 300c from left to right as indicated by an arrow 310 in FIG. 9, the acceleration sensor 110 of each electronic paper display device detects the moving direction to output the signal indicative of the moving direction to the process command controller 111.

The process command controller 111 performs necessary processing on the signal received from the acceleration sensor 110, such as analog-to-digital conversion, and feeds the processed signal to the system controller 106.

The system controller 106 receives the signal from the process command controller and then confirms whether or not another electronic paper display device is connected to the own electronic paper display device 300a in the moving direction. In the illustrative example, as viewed from the electronic paper display device 300b in FIG. 9, the electronic paper display device 300a is connected to the right edge of the electronic paper display device 300b, and the electronic paper display device 300c is also connected to the right edge of the electronic paper display device 300a.

The system controller 106 of the electronic paper display device 300a in turn reads out the document file data stored in the RAM 108 and provides an instruction to the signal processor 105 to transmit the data thus read out as well as the page number data, which page is currently displayed on the display panel 101, to the electronic paper display device 300c connected to the right edge of the electronic paper display device 300a.

The signal processor 105 follows the instructions to perform necessary signal processing on the document file data and page number data in order to formulate the data acceptable for the specifications of the socket 102, and feeds the data thus processed to the socket 102.

From the socket 102 of the electronic paper display device 300a, the data is then transmitted to the connector plug 103 of the electronic paper display device 300c.

The system controller 106 of the electronic paper display device 300b experiments with the similar processing as the system controller 106 of the electronic paper display device 300a, but the processing is aborted due to no document file stored in the RAM 108 of the electronic paper display device 300b.

From the socket 102 of the electronic paper display device 300a, the data is then transmitted to the connector plug 103 of the electronic paper display device 300c.

When receiving the data transmitted from the socket 102 of the electronic paper display device 300a, the connector plug 103 of the electronic paper display device 300c feeds the data to the signal processor 105 of the electronic paper display device 300c.

The signal processor 105 of the electronic paper display device 300c performs necessary processing on the data, such as analog-to-digital conversion, so as to feed the processed data to the system controller 106. The system controller 106 has the RAM 108 store the data.

The system controller 106 of the electronic paper display device 300c follows the program instructions of the document reader application to read out the document file data and page number data from the RAM 108 and allows the display controller 104 to display the document on the display panel 101. Note that, the system controller 106 of the electronic paper display device 300c may have the display controller 104 display the document on the page following the page corresponding to the page number received from the electronic paper display device 300a.

When the user moves the electronic paper display devices 300a, 300b and 300c from right to left as indicated by an arrow 312 in FIG. 9, the similar processing is performed between the electronic paper display devices 300a and 300b. In this case, the system controller 106 of the electronic paper display device 300b may cause the display controller 104 to display the document on the page preceding the page corresponding to the page number received from the electronic paper display device 300a.

In this way, in accordance with the illustrative example, it is possible to perform data sharing between applications installed in the respective electronic paper display devices as indicated by arrows 320 and 322 whereby the user can read through three consecutive pages by connecting the three electronic paper display devices.

In the illustrative embodiment, data is shared between the document reader applications by way of example. However, any other applications may be applied.

In the electronic paper display device shown in FIGS. 8 and 9, the electronic paper display device 300 includes the acceleration sensor 110 to detect the moving direction of the electronic paper display device 300. It is therefore possible for the user to instruct the electronic paper display device 300 as to whether the data is transmitted or received by moving the electronic paper display device 300, whereby it is possible for the user to decide, arbitrarily, the order or sequence of connecting the electronic paper display devices and the direction of data transfer in the connected electronic paper display devices.

In addition, in the electronic paper display devices 300, data sharing is achieved by the sensuous manipulation, such as movement, of the electronic paper display device 300 so that a user-friendly system for data sharing can be provided.

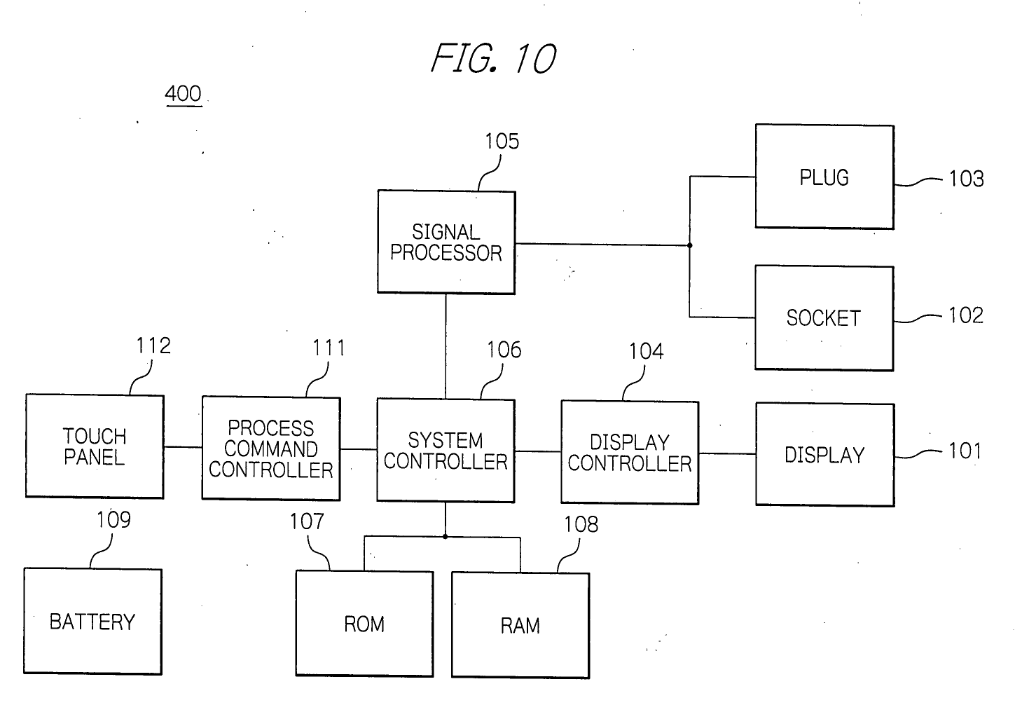

Further reference will be made to FIG. 10, which is a schematic block diagram, like FIGS. 1 and 8, showing another alternative embodiment of the electronic paper display device according to the present invention. In the electronic paper display device 400 shown in FIG. 10, the data transfer direction is settable in advance by the user, so that when electronic paper display devices are connected, data is transmitted and received in compliance with the data transfer direction thus set up, as discussed in detail below.

The electronic paper display device 400 includes a touch panel 112 in addition to the display panel 101, connector socket 102, plug 103, display controller 104, signal processor 105, system controller 106, ROM 107, RAM 108, battery 109 and process command controller 111. In FIG. 10, structural parts and elements like those shown in FIGS. 1 and 8 are designated by identical reference numerals, and will not be described repetitively in order to avoid redundancy.

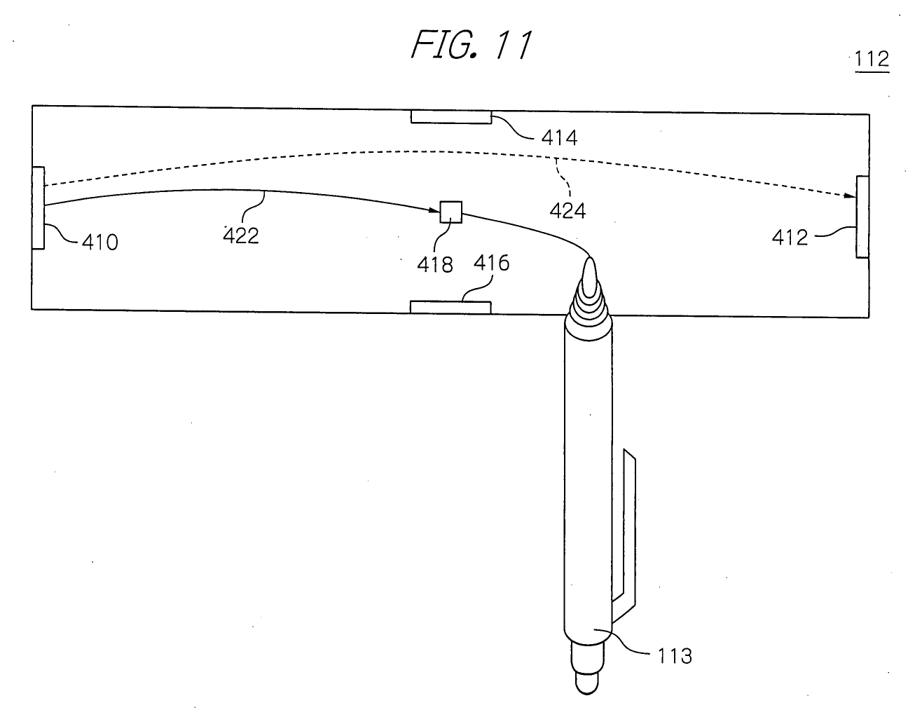

The touch panel 112 is manipulatable by the user for inputting desired commands with an input device such as a stylus or an electronic pen, or a finger. In the instant alternative embodiment, the user uses an input device 113 like a stylus pen as shown FIG. 11, and the touch panel 112 is responsive to the user's operation to send out an operation signal to the process command controller 111. The process command controller 111 performs necessary processing on the signal output from the touch panel 112.

Note that, the touch panel 112 may be either separately provided from or combined with the display panel 101 to form, e.g. a touch screen, of the electronic paper device 400.

Also, the touch panel 112 shown in FIG. 10 is only illustrative, and may be changed or modified as desired. For example, a pen-shaped input device may be used which is provided with a digital camera designed to digitally record a path traced by the pen-shaped input device.

FIG. 11 is a front view schematically showing the touch panel 112 shown in FIG. 10. With reference to FIG. 11, it will be described how to designate the flow of data transmitted and received by the use of the touch panel 112.

In FIG. 11, on the left, right, top and bottom of the touch panel 112, icons 410, 412, 414 and 416 are displayed respectively. Each icon represents another electronic paper display device which is connected to the electronic paper 400 on which it is installed. For example, the icon 410 represents the other electronic paper display device connected to the left side of the electronic paper 400 in question. The same is equally true of the icons 412, 414 and 416. On the touch panel 112, an icon 418 is also displayed in the center to represent the electronic paper device 400 in question.

With the use of the input device 113, the user can connect the icons with a line in order to input a data transfer direction to the electronic paper device 400. In the illustrative example, the user connects the icon 410 to the icon 418 with a line 422, so that the data transfer direction is set up in order that, when the left connector plug 103 of the electronic paper device 400 in question is inserted into the right socket 102 of a left electronic paper display device connected thereto, data is to be transferred from the left electronic paper display device to this electronic paper device on which the touch panel 112 is carried on.

It is also possible to set up a data transfer direction freely. For example, the user can connect the icon 414 to the icon 416, or connect the icon 410 to the icon 412 over the icon 418 as indicated by a dashed line 424 in FIG. 11.

The setting of a data transfer direction may be erased or reset after the expiration of a predetermined time interval, so that another data transfer direction can be set up.

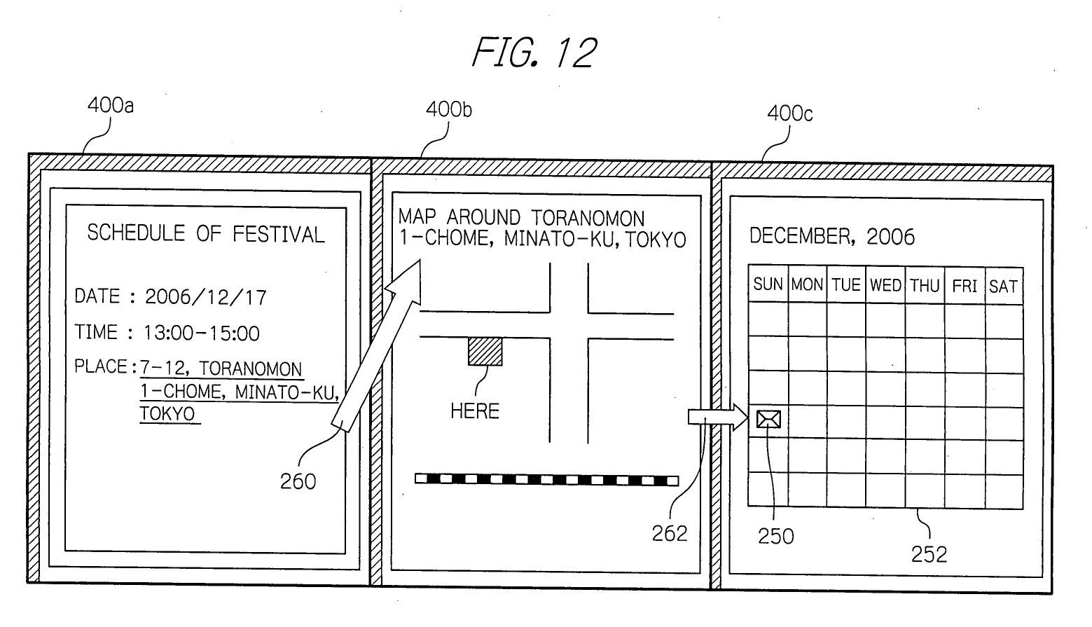

Next, an example of data sharing between the electronic paper display devices 400 will be described with reference to FIG. 12, which schematically shows an example of sharing data between document reader applications in the electronic paper display devices 400.

In FIG. 12, the electronic paper display devices 400a, 400b and 400c are substantially the same as the electronic paper display devices 100a, 100b and 100c except that the electronic papers 400a, 400b and 400c are operated by the user using the touch panel 112, so that, in the ROM 107 of the electronic paper 400a, a Web browser application is installed, and a Web page is displayed as shown in FIG. 12. Also, in the ROMs 107 of the electronic papers 400b and 400c, a map and a scheduling application are installed, respectively, and are on standby and ready for an execution of the data sharing.

The user sets up the data transfer direction by using the touch panel 112 of the electronic paper display device 100b and input device 113 as described above with reference to FIG. 11. More specifically, in the instant alternative embodiment, the user connects the icon 410 to the icon 418 as indicated by a line 422. The use also connects the icon 410 to the icon 412 as indicated a dashed line 424.

In FIG. 12, only the data sharing between the electronic paper display devices 400a and 400b is illustrated. However, the data sharing between the electronic paper display device 400a and 400c is substantially the same as the data sharing between the electronic paper display devices 400a and 400b and will not be described specifically in order to avoid redundancy.

In order to execute data sharing between the electronic paper display devices 100a and 100b, the user inserts the connector plug 103 of the electronic paper display device 400b into the connector socket 102 of the electronic paper display device 400a.

When the connector plug 103 of the electronic paper display device 400b is inserted into the socket 102 of the electronic paper display device 400a, the signal processor 105 of the electronic paper display device 400a receives a signal indicating a notification of the connection from the socket 102, and outputs the signal to its own system controller 106.

The system controller 106 of the electronic paper display device 400b controls the signal processor 105 of the electronic paper display device 400b to receive the data transmitted from the electronic paper display device 400a connected on its left side, so that the signal processor 105 of the electronic paper display device 400b controls the connector plug 103 to output a request for data transmission to the socket 102 of the electronic paper display device 400a.

The connector socket 102 of the electronic paper display device 400a receives the request for data transmission from the connector plug 103 of the electronic paper display device 400b and feeds the request to the signal processor 105 of the electronic paper display device 400a.

The signal processor 105 of the electronic paper display device 400a performs necessary processing of the request, such as analog-to-digital conversion, so as to feed the processed signal to the system controller 106. In response to the request for data transmission, the system controller 106 of the electronic paper display device 100a starts the operation for outputting the data stored in the RAM 108 to the electronic paper display device 100b.

The subsequent procedure may be substantially the same as the procedure described above with reference to FIG. 7, and will not be described repetitively in order to avoid redundancy.

After transmitting and receiving the data from the electronic paper display devices 400a to the electronic paper display device 400b, on the display panel 101 of the electronic paper display device 400b, the map image of the location is displayed as shown in FIG. 12. Similarly, substantially the same process is executed between the electronic paper display devices 400a and 400c so that the data stored on the electronic paper display device 400a is transferred to the electronic paper display device 400c through the center electronic paper display device 100a whereby the schedule data of the scheduling application is updated in the electronic paper display device 400c.

In this way, once the data transfer direction is set up in one electronic paper display device, the other electronic paper display devices connected to the one electronic paper display device in question can transmit or receive the data or signal under the control of the one electronic paper display device.

In the instant alternative embodiment, the data transfer direction between electronic paper display devices can be arbitrarily set up by the user. It is therefore possible to implement advanced data sharing between applications installed in the respective electronic paper display devices.

In addition, the data transfer direction can be set up by sensuous operation using a touch panel, and thereby the invention can achieve a user-friendly system for interfacing applications.

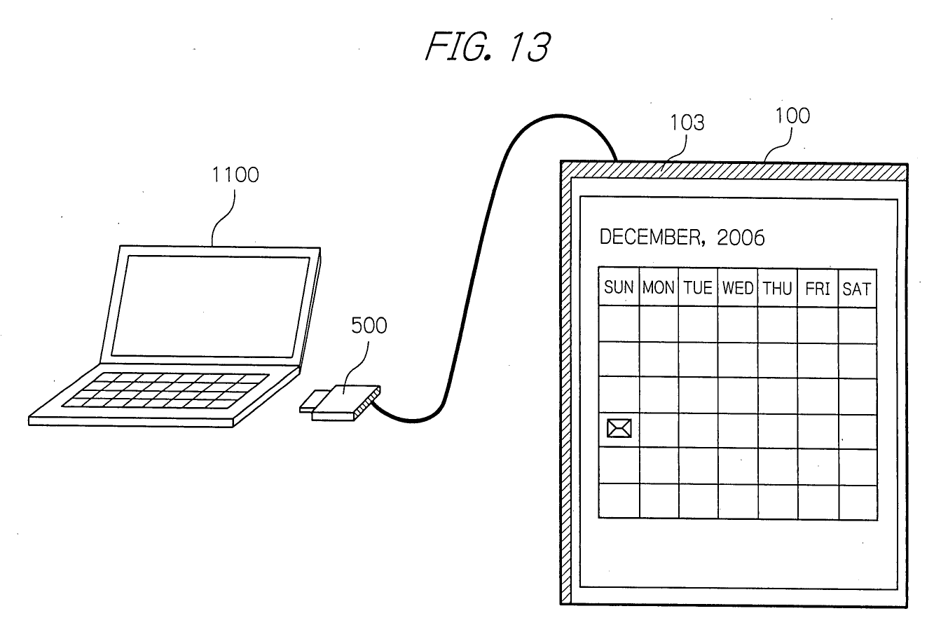

FIG. 13 schematically shows an example of connection between a computer 1100 and the electronic paper display device 100. In the figure, the electronic paper display device 100 is connected to, e.g. a personal computer 1100 so as to receive a program file of an application to be installed, as discussed in detail below.

Of course, the electronic paper display devices 300 and 400 of the illustrative embodiments can receive desired file such as word-processed files, text files and the like from the computer 1100. Also, the electronic paper display device 100 may receive a desired file over a telecommunications network such as the Internet.

The electronic paper display device 100 is provided with a known connection cable, e.g. a removable USB (Universal Serial Bus) connection cable 500 which can be connected at one end to the connector plug 103 and at the other end to the computer 1100 when having a USB-compatible interface.

The electronic paper display device 100 receives an application program to be stored in the ROM 107 and data to be stored in the RAM 108 from the computer 1100 over the USB connection cable.

The application program and data thus received are fed to the system controller 106 through the signal processor 105. The system controller 106 stores the application program in the ROM 107 and the data in the RAM 108. Note that, the ROM 107 may be a known rewritable type of storage, such as a flash EEPROM (Flash Electrically Erasable Programmable ROM).

As has been discussed above, in accordance with the embodiment, it is possible to obtain a desired program sequence and data, even if the electronic paper display device has no function for connecting to a telecommunications network.

The entire disclosure of Japanese patent application No. 2006-350244 filed on Dec. 26, 2006, including the specification, claims, accompanying drawings and abstract of the disclosure, is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. An electronic paper display device comprising:
a display for displaying image or text data;
a storage for storing the image or text data to be displayed on said display;
a controller for controlling said display; and
an interface for interfacing another electronic device to transmit or receive data to or from the other electronic device,
said storage storing a program sequence for analyzing the data received through said interface,
said interface feeding, when receiving the data from the other electronic device, the data received to said controller, so that said controller reads out and runs the program sequence stored in said storage to analyze the data, and controlling said display to display the data analyzed.

2. The electronic paper display device in accordance with claim 1, wherein said interface comprises a first connector connectable to the other electronic device for transmitting data,
said controller being responsive to said first connector connected to the other electronic device to read out the data stored in said storage to feed the data read out to said first connector, so that said first connector transmits the data fed to the other electronic device.

3. The electronic paper display device in accordance with claim 2, wherein said interface comprises a second connector connectable to the other electronic device for receiving data.

4. The electronic paper display device in accordance with claim 1, further comprising an acceleration sensor for detecting an acceleration of said electronic paper display device to feed a signal indicative of a moving direction of said electronic paper display device,
said controller being responsive to the signal to read out data corresponding to the moving direction to cause said interface to transmit the data read out to the other electronic device connected to said electronic paper display device.

5. The electronic paper display device in accordance with claim 1, further comprising an acceleration sensor for detecting an acceleration of said electronic paper display device to feed a signal indicative of a moving direction of said electronic paper display device,
said controller being responsive to the signal to read out data corresponding to the moving direction to cause said interface to receive data transmitted from the other electronic device connected to said electronic paper display device.

6. The electronic paper display device in accordance with claim 1, further comprising an input device for inputting an instruction on a data transfer direction in which data is transmitted from or to said electronic paper display device,
said controller being responsive to the other electronic device connected to said interface to read out data corresponding to the data transfer direction from said storage to cause said interface to transmit the data read out to the other electronic device connected in the data transfer direction.

7. The electronic paper display device in accordance with claim 6, wherein said display visually displays an interconnection of said electronic paper display device to the other electronic device,
said input device being provided on said display to receive the instruction while said display displays the interconnection.

8. The electronic paper display device in accordance with claim 1, further comprising a wireless communication apparatus for transmitting or receiving data on a wireless connection,
said controller controlling said wireless communication apparatus to be connected to a telecommunications network to transmit or receive data to or from the network over the wireless connection.

9. The electronic paper display device in accordance with claim 1, wherein said interface comprises a third connector connectable to a computer for receiving data or a program sequence from the computer,
said controller being responsive to said third connector to store the data or program sequence received in said storage.

10. A system for interfacing an application between at least two electronic paper display devices, each of which comprises:
a display for displaying image or text data;
a storage for storing the image or text data to be displayed on said display;
a controller for controlling said display; and
an interface for interfacing the other of said electronic paper display devices to transmit or receive data to or from said other electronic paper display device,
said storage storing a program sequence for analyzing the data received through said interface,
said interface feeding, when receiving the data from said other electronic paper display device, the data received to said controller, so that said controller reads out and runs the program sequence stored in said storage to analyze the data, and controlling said display to display the data analyzed,
said at least two electronic paper display devices being interconnected to each other through said interface of each of said at least two electronic paper display devices to transmit or receive the data between to or from said at least two electronic paper display devices.

11. An electronic paper display device comprising:
a display for displaying image or text data;
a storage for storing the image or text data to be displayed on said display;
a controller for controlling said display; and
an interface for interfacing another electronic device to receive data from the other electronic device,
said storage storing a program sequence for analyzing the data received through said interface,
said interface feeding, when receiving the data from the other electronic device, the data received to said controller, so that said controller reads out and runs the program sequence stored in said storage to analyze the data, and controlling said display to display the data analyzed.

12. An electronic paper display device comprising:
a display for displaying image or text data;
a storage for storing the image or text data to be displayed on said display;
a controller for controlling said display; and
an interface for interfacing another electronic device to transmit data to the other electronic device,
said storage storing a program sequence for transmitting the data stored in said storage through said interface,
said controller having said interface transmitting the data to the other electronic device connected to the electronic paper display device.
